(19) United States
(12) Patent Application Publication
(10) Pub. No.: US 2013/0193763 A1
(43) Pub. Date: Aug. 1, 2013

(54) INTRINSICALLY SAFE BACKUP POWER SUPPLY FOR COMBUSTIBLE ENVIRONMENTS

(71) Applicants: Jian Zhao, Shanghai (CN); Clive Brooks, Kurrajong Hills (AU)

(72) Inventors: Jian Zhao, Shanghai (CN); Clive Brooks, Kurrajong Hills (AU)

(73) Assignee: Conspec Controls Limited, Burlington, ON (CA)

(21) Appl. No.: 13/880,367

(22) PCT Filed: Oct. 18, 2010
(86) PCT No.: PCT/CA2010/001648

§ 371 Date: Apr. 18, 2013

(51) Int. Cl. H02J 9/06; H02J 7/00

(52) U.S. Cl. CPC H02J 9/06; H02J 7/0068
USPC 307/65; 307/66

(57) ABSTRACT

An intrinsically safe supply for supplying back-up power during a power-out event incorporates one or more rechargeable fuel cells. The power supply is provided with switching circuitry operable to provide an output back-up current from the fuel cells upon a power-out event. The fuel cells are housed within a sealed metal housing immersed within an electricity insulating potting material chosen to arrest spark formation and/or electrically insulate any created sparks. The fuel cells comprise sealed lithium iron based fuel cells for supplying back-up electrical current. A charging circuit electrically connects the fuel cells with an external power source for providing a charging current during normal power-on conditions.

### SCOPE OF THE INVENTION

The present invention relates to an emergency or back-up power supply, and more particularly an intrinsically safe (IS) power supply suitable for use in potentially combustible environments such as underground mine applications, petrochemical and refinery installations, and other environments where potentially combustible gases or materials may be present.

### BACKGROUND OF THE INVENTION

In coal and other underground mine environments, it is necessary to continuously monitor mine air quality to ensure that levels of explosive methane gas do not exceed operationally safe levels where underground fires or explosions could occur. Conventionally, when methane gas levels are identified as exceeding safe levels, all external power into the coal mine is severed. Mine operations thereafter proceed without conventional power to reduce the likelihood of sparking and other ignition sources until such time as the air quality returns to normal levels. During power-out events, mine gas sensors, lighting and ventilation equipment operate by back-up DC battery power supply.

Conventional back-up battery systems incorporate a single or multiple rechargeable conventional batteries, which may be of a lead acid (usually SLA, or recombination type), nickel cadmium, or nickel metal hydride design. Conventional batteries suffer various disadvantages. Most notably, conventional batteries may emit hydrogen gas which, in the presence of electrical sparks, may on its own combust. In addition, if improperly charged, the batteries may in themselves overheat and present a risk of explosion providing a further catalysis for igniting methane mine gases and/or the emission of harmful battery electrolytes. Further, because conventional batteries produce hydrogen, the containers they are mounted in must vent to atmosphere, to prevent excessive pressure build-up and case failure. Typically vents must be made of a sintered mat metal that allows gas to escape but which prevents ignition of the internal stored gas from an external ignition source.

In addition to having a low stored power to weight ratio, conventional batteries suffer further disadvantages in that when repeatedly charged and discharged over multiple power-out events, the batteries are prone to sulfation, ultimately losing their ability to maintain an electric charge, losing effectiveness.

### SUMMARY OF THE INVENTION

The present invention seeks to provide an improved intrinsically safe (IS) power supply suitable for use to provide emergency or back-up power in environments where combustible or other hazardous gases and/or materials may be present, while minimizing the explosive threats and electrical sparks associated with conventional batteries in the event of overcharging.

Another object of the invention is to provide an IS power supply which is constructed to minimize the possibility of electrical sparking at battery terminals and/or across electrical connections which could otherwise ignite explosive gases and/or flammable materials.

A further object of the invention is to provide a back-up power supply for supplying emergency power to underground mines, and which includes thermal overload protection to minimize the threat of battery explosion in the event of an overcharged condition.

A further object of the invention is to provide a battery based power supply for providing emergency back-up power during a power-out event which incorporates one or more electrically rechargeable lithium ion fuel cells, and preferably sealed lithium iron phosphate fuel cells individually encased within an electrically insulating potting material.

Accordingly, in a simplified embodiment, the present invention provides a power supply for supplying back-up power during a power-out event. Most preferably, the power supply incorporates one or more rechargeable fuel cells and is provided as an inherently safe power supply constructed to minimize the creation of sparks, fuel cell rupture and/or explosion, so as to be suitable for use in potentially combustive environments such as underground mine applications, petrochemical refinery, and storage facilities, and other environments where combustible gases and/or flammable materials and liquids may be present. The power supply is provided with switching circuitry operable to provide an output back-up current from the fuel cells upon a power-out event.

The fuel cells are preferably housed within a sealed metal housing. The fuel cells are at least partially immersed within an electrically insulating potting material which is chosen to arrest spark formation and/or to electrically insulate any created sparks from the surrounding atmosphere. In one possible construction, the fuel cells comprise one or more sealed lithium ion batteries and preferably lithium iron phosphate based fuel cells for supplying a back-up electrical current, and which are substantially or fully encased within silicone as a potting material. A charging circuit electrically connects one or more fuel cells with an external power source for providing a charging current during normal power-on conditions. Preferably the lithium iron phosphate batteries comprise generally cylindrical sealed lithium iron phosphate batteries. Each sealed battery is more preferably individually encased within the potting material in either a generally square packed or hexagonally packed orientation.

Accordingly, in one aspect the present invention resides in an underground mine supply for supplying back-up power to an underground mine in a power-out event, the power supply including: a housing, an electrically insulating potting material, at least one lithium iron based fuel cell for supplying a back-up current during said power-out event, each said fuel cell being disposed within said housing and substantially encased within said potting material, a charging circuit electrically connected to a first one of said fuel cell and an external power source for providing a charging current to said first fuel cell during normal power-on conditions, and a switching power circuit electrically connecting at least one said fuel cell and a power supply output for outputting said backup current during said power-out event.

In another aspect, the present invention resides in a power supply for supplying back-up power during a power-out event, the power supply including: a housing, an electrically insulating potting material, a fuel cell array comprising a plurality of fuel cells for supplying a back-up current during said power-out event, each said fuel cell being disposed within said housing and substantially encased within said potting material, at least one conductor bridge electrically connecting a plurality of said fuel cells in series or parallel, the connector bridge including at least one current interrupting member which is actuable to interrupt current flow in the event of a preselected triggering condition, a charging circuit electrically connected to a first said fuel cell and an external power source for providing a charging current to said first fuel cell during normal power-on conditions, and a switching power circuit electrically connecting the fuel cell array and a power supply output for outputting said backup current during said power-out event.

In a further aspect, the present invention resides in an power supply for supplying backup power during a power-out event, the power supply including, a housing, an electrically insulating silicone potting material, at least one fuel cell array comprising a plurality of electrically rechargeable lithium iron phosphate fuel cells for supplying a backup current during said power-out event, the fuel cells being generally of equal size and disposed in an aligned and hexagonally packed orientation to define longitudinally extending interspaces therebetween, said fuel cells being electrically connected in series and disposed within said housing substantially individually encased within said potting material, at least one conductor bridge electrically connecting a plurality of said fuel cells in series, the connector bridge including at least one current interrupting member which is actuable to interrupt current flow in the event of a preselected triggering condition, a charging circuit electrically connected to a first one of said fuel cell and an external power source for providing a charging current to said fuel cell array during normal power-on conditions, and a switching power circuit electrically connecting at least one said fuel cell and a power supply output for outputting said backup current during said power-out event.

### BRIEF DESCRIPTION OF THE DRAWINGS

Reference may now be had to the following detailed description, taken together with the accompanying drawings, in which:

FIG. 1 illustrates schematically an inherently safe power supply in accordance with a preferred embodiment of the invention;

FIG. 2 shows a schematic side view of the power supply shown in FIG. 1;

FIG. 3 shows a schematic perspective view of the fuel cell unit used in the power supply of FIG. 1;

FIG. 4 shows a schematic top view of the fuel cell unit shown in FIG. 3;

FIG. 5 illustrates an enlarged partial cross sectional view of the fuel cell unit shown in FIG. 4, taken along line 4-4.

FIG. 6 illustrates schematically the electrical top connections for the rechargeable batteries used in the fuel cell unit shown in FIG. 3;

FIG. 7 shows schematically the electrical button connections for the rechargeable batteries used in the fuel cell unit shown in FIG. 4;

FIG. 8a illustrates a hexagonal packing arrangement for the rechargeable batteries used in the fuel cell unit of FIG. 3;

FIG. 8b illustrates a square packing arrangement for the rechargeable batteries, in accordance with an alternate embodiment of the invention;

FIG. 9 shows schematically a circuitry diagram for a charger/battery management circuit used to provide a charging current to the fuel cell array;

FIG. 10 illustrates schematically an IS switching power circuit used to output emergency back-up current on the occurrence of a power-out event;

FIG. 11 illustrates schematically a circuitry diagram for a pre-regulator circuit used in the IS switching power circuit of FIG. 10; and

FIG. 12 shows schematically a circuitry diagram for an active resistive shunt regulator circuit used in the IS switching power circuit of FIG. 10.

### DETAILED DESCRIPTION OF THE PREFERRED EMBODIMENTS

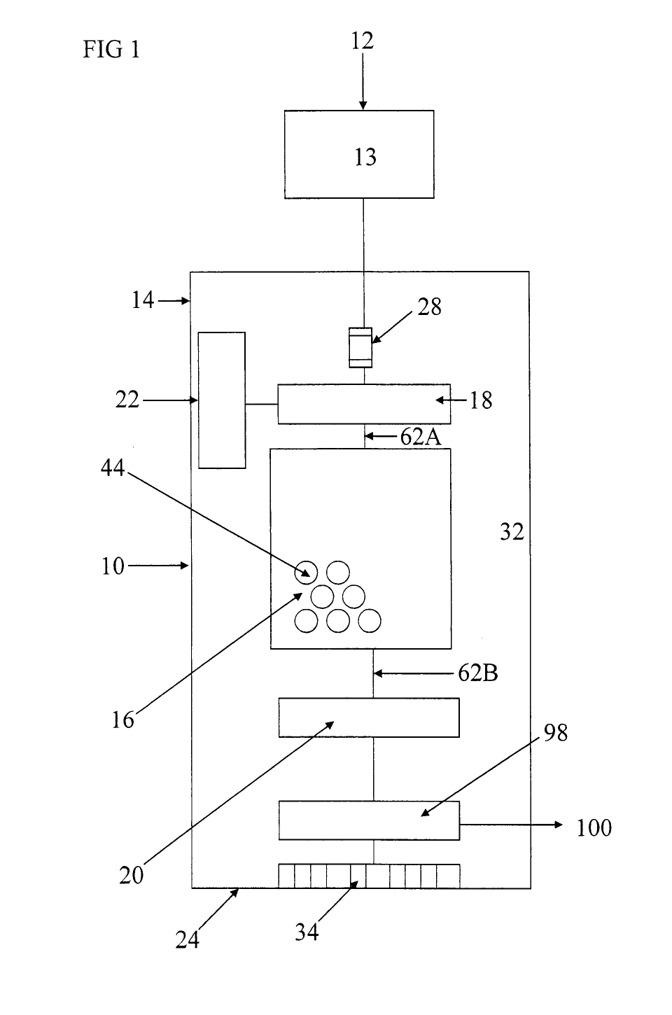

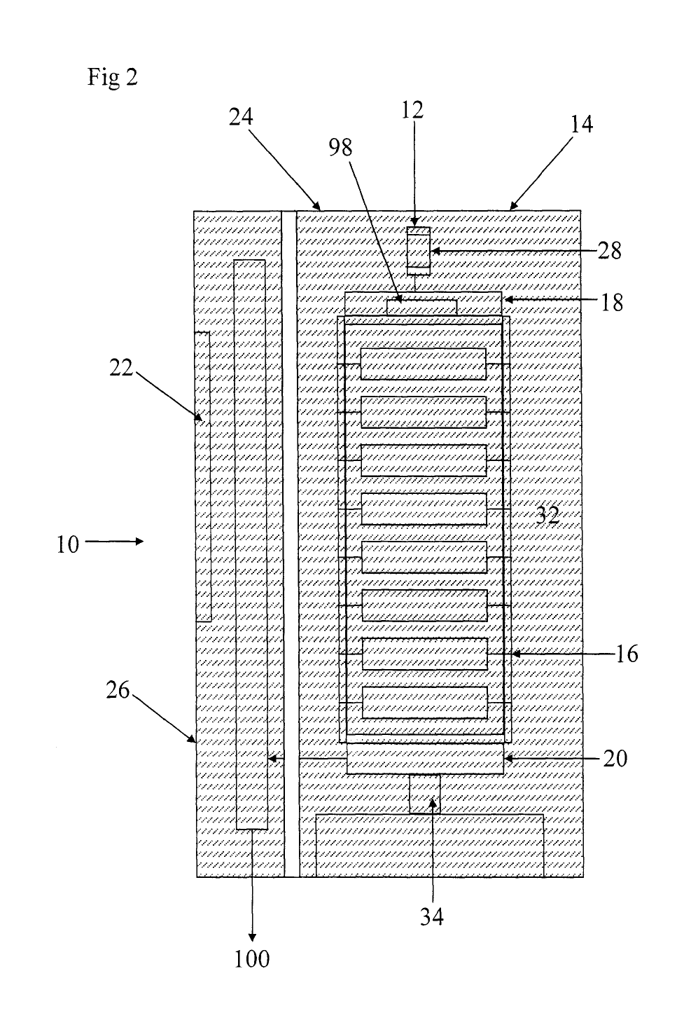

Reference is had to FIGS. 1 and 2 which illustrate an underground mine power supply 10 for supplying intrinsically safe (IS) back-up electrical power to a mine installation. The power supply 10 is electrically connected to the mine AC power grid 12 by way of AC/DC 15-volt output power supply 13. The grid 12 provides charging DC power to the power supply 10 during normal mine operating conditions. The power supply 10 provides emergency back-up DC power via output 100 therefrom to run mine lighting, ventilation and gas sensing systems in the event of a power-out occurrence, as for example when methane gas levels exceed safe levels, necessitating the shut down of outside AC power to the mine. As will be described, the power supply 10 is constructed as an intrinsically safe power supply enabling its installation and use underground within the mine itself, in regions where explosive methane gases may accumulate. The power supply 10 is constructed with a total overall weight of approximately 5 to 14 kg, and more preferably about 8 to 10 kg, allowing for its simplified transport, installation and replacement below ground.

FIG. 1 shows best the power supply 10 as including a housing 14, a fuel cell unit 16 for storing and supplying emergency back-up power, a charger/battery management circuit 18 for providing a charging current to the fuel cell unit 16 during normal mine operations; and an IS switching power circuit 20 which is operable to provide output back-up current in the event of a power-outage. An overload fuse 28 is preferably provided between the grid 12 and the charger/battery management circuit 18 to prevent any overcurrent thereto. Optionally, the power supply 10 may be provided with a LCD display 22 (FIG. 2) and a keypad or touch screen for operator interrogation of the power supply 10. Data acquisition and/or control could, however, optionally include low power microprocessor systems with interfaces for serial or network communications, with or without network switches. Such network interfaces may be either copper wired or fiber optic ethernet based, with extra circuitry fitted to the housing 14. In a further embodiment, data acquisition and control systems may be used to configure the power supply 10 as a communications gateway for the control and monitoring of sensors and detectors.

The display 22 is adapted to provide a visual indication of current power supply status, including whether or not the power supply 10 is in a fully charged, charging or discharging mode of operation; as well as information as to power loading and expected battery life.

In a most simplified construction, the housing 14 is formed as a metal, and more preferably coated and/or stainless steel box 24, and includes removable lid 26 which is screw-fit thereto in place. For enhanced portability and ease of installation, the housing 14 preferably has an overall length and width selected at between about 0.4 and 0.8 m, and height of between about 0.2 and 0.6 m. A larger or smaller sized housing 14 may however be used, depending on anticipated back-up power loads and voltage and current requirements.

The fuel cell unit 16 is coupled to a heat sink 34 used to dissipate heat generated by the fuel cell unit 16. The heat sink 34 is designed to transmit heat from the fuel cell unit 16 to the outside of the housing 14. In a simplified construction, the heat sink 34 is formed as a flat plate, without fins, and is preferably made of copper or aluminium.

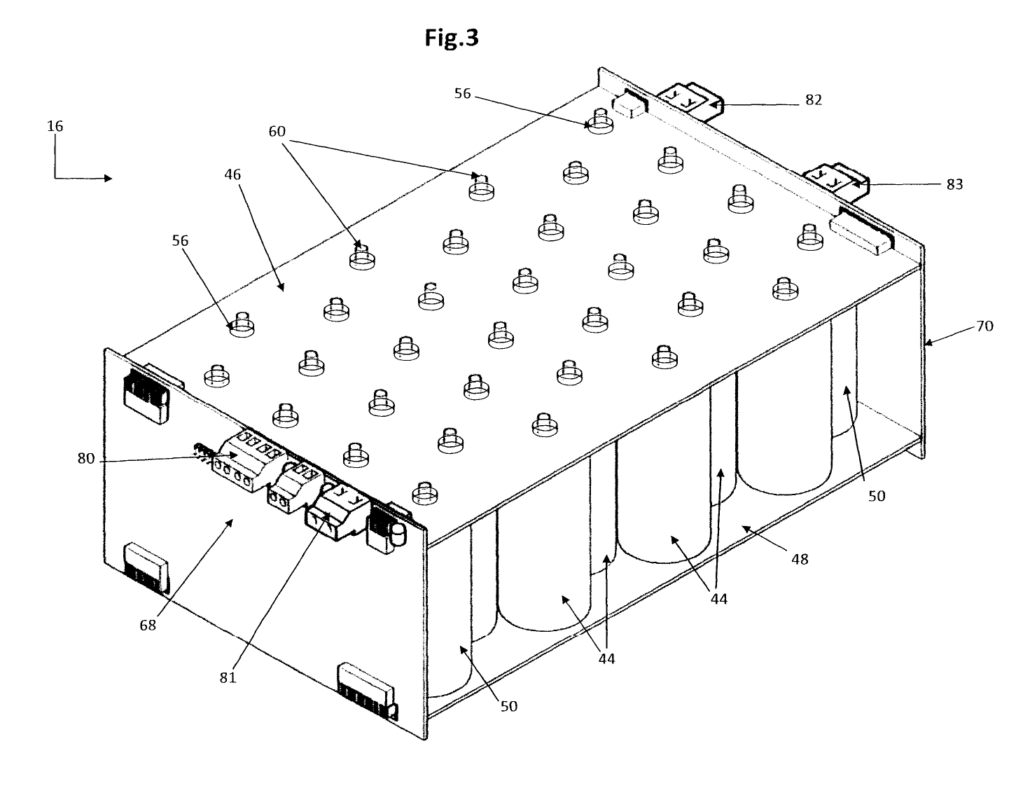

A preferred fuel cell unit 16 is illustrated best in FIGS. 3 to 5. In the embodiment shown, the fuel cell unit 16 is provided with four electrically parallel fuel cell arrays A,40B,40C,40D which are connected to each other in series. It is to be understood however, that in other constructions, the fuel cell unit 16 could include a fewer or greater number of fuel cell arrays 40, depending on the power supply, power output and/or size requirements. Each fuel cell array 40A-D consists of eight generally cylindrical rechargeable lithium iron phosphate batteries 44. As will be described, the fuel cell unit 16 is assembled having a box-like construction unit with the fuel cell arrays 40A,40B,40C,40D disposed within a rectangular box-like structure defined by parallel top and bottom carrier cards 46,48 which are joined at each end by mounting boards 68,70. Printed circuit traces 62a,62b (FIG. 1) are used to electrically couple the fuel cell unit 16 to the charger/battery management and switching power circuits 18, respectively.

The charger/battery management circuit 18 is formed on the mounting board 68, and which is also used to mount battery bank charge balancing circuitry. The IS switching power circuit 18 formed on board 70. The boards 68,70 electronically plug onto the ends of the top and bottom battery carrier cards 46,48, such that no separate wires are used. The boards 68,70 and cards 46,48 form the rectangular box with the batteries 44 mounted vertically between the top and bottom cards 46,48.

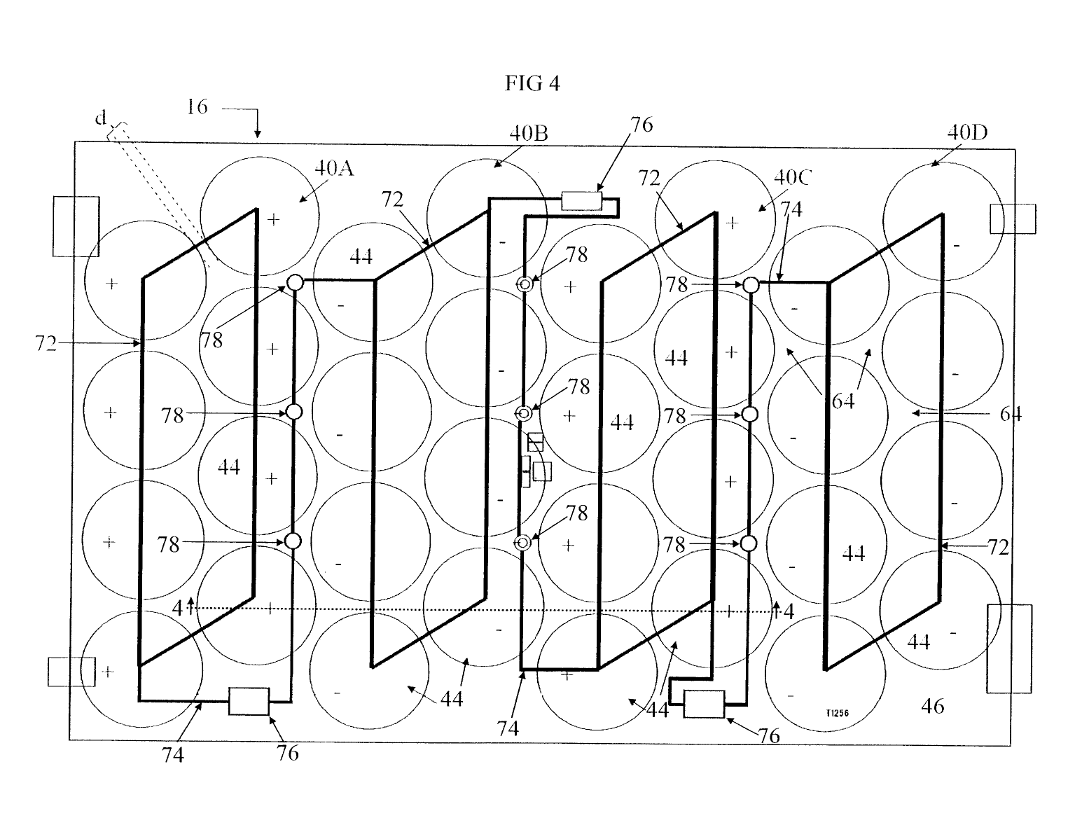

The batteries 44 are oriented in a generally parallel aligned orientation between the top and bottom mounting cards 46,48. The batteries 44 are shown best in FIG. 4 as being connected in each of the four arrays 40A-D as arranged with a common polar orientation in parallel groups of 2×4 cells in the vertical plane. Preferably, the batteries 44 each comprise a 3.2 volt battery provided with a cylindrical stainless steel casing 50 having sealed top and bottom ends 52a,52b. Each battery casing 50 has a radial diameter selected at between about 20 and 40 mm, and preferably about 32 mm; and an axially length selected at about 6 to 10 cm, and most preferably about 7.5 cm. The batteries 44 provide a current discharge rate of approximately 2 amps.

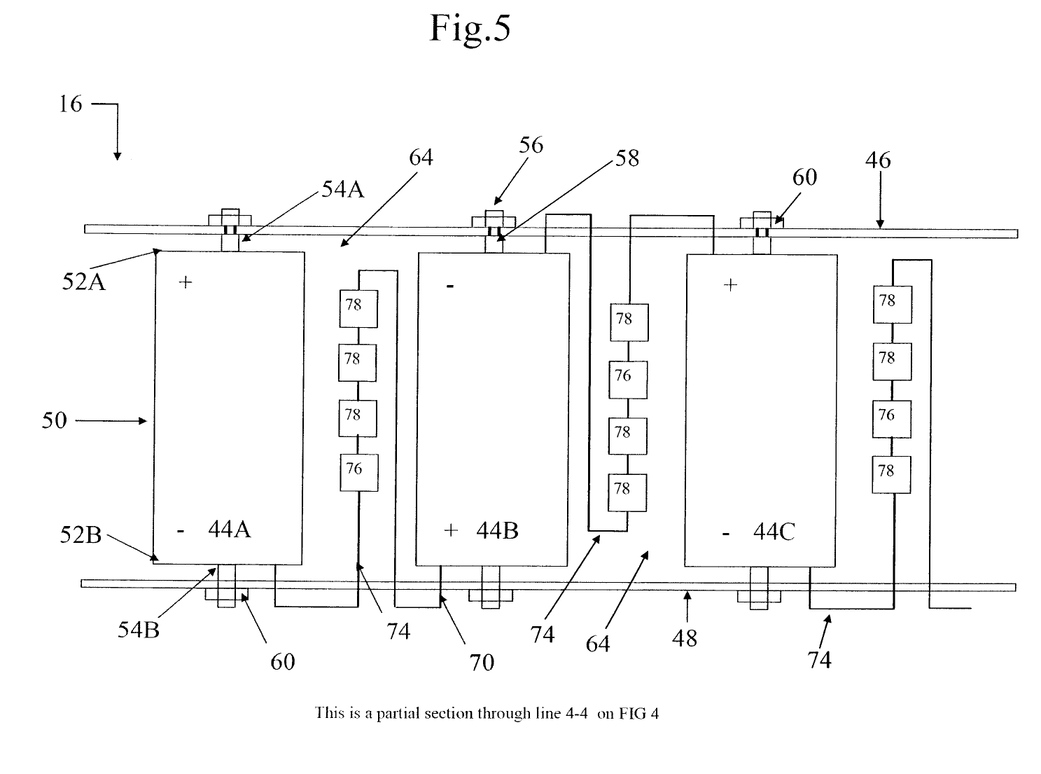

An axially extending mounting post 54a,54b projects from each respective battery end 52a,52b. The posts 54a,54b are provided with a reduced diameter threaded end tip 56 which extends axially from a shoulder 58. The threaded end tips 56 are sized for insertion through complimentary sized boreholes formed in the top and bottom mounting cards 46,48, so as to be threadedly engaged by threaded nut fasteners 60. As shown best in FIGS. 3 and 5, the insertion and securement of the end tip 56 in the boreholes, and the use of the nuts 60, enables the batteries 44 to be secured in a sandwiched arrangement between the top and bottom mounting cards 46,48.

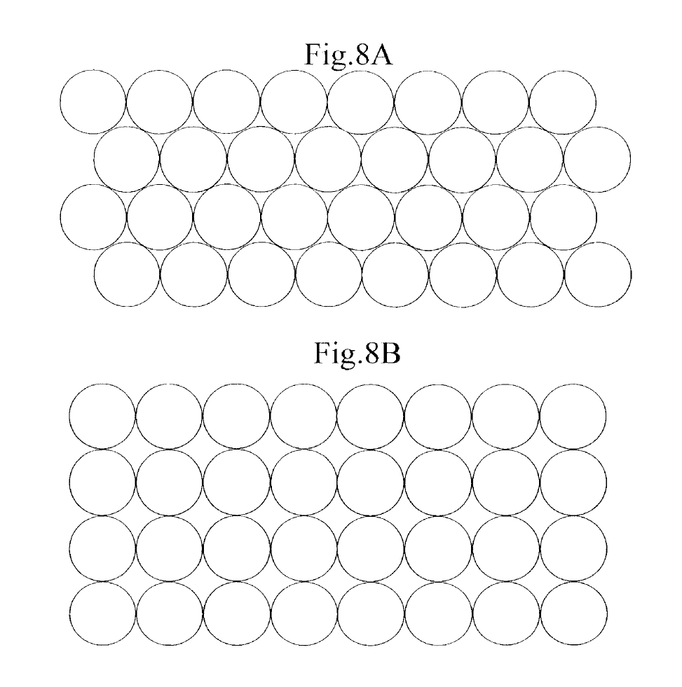

As shown best in the schematic top view illustrated in FIG. 4, the batteries 44 of the fuel cell unit 16 are coupled between the top and bottom mounting cards 46,48 in a generally hexagonally packed array formation, as for example is shown in FIG. 8A. Most preferably, the batteries 44 are mounted between the cards 46,48 in position with a minimum separation distance (d) between immediately adjacent batteries 44 selected at between about 1.0 to 4.0 mm, and preferably about 2.0 mm. In the hexagonally packed array shown, the relative battery positioning further results in generally hyperbolic triangular shaped interspaces 64 which extend from the top mounting board 46 to the bottom mounting board 48. In particular, each interspace 64 is generally defined as the relatively large spacing which exists between the cylindrical sidewalls 50 of a cluster of three immediately adjacent batteries 44.

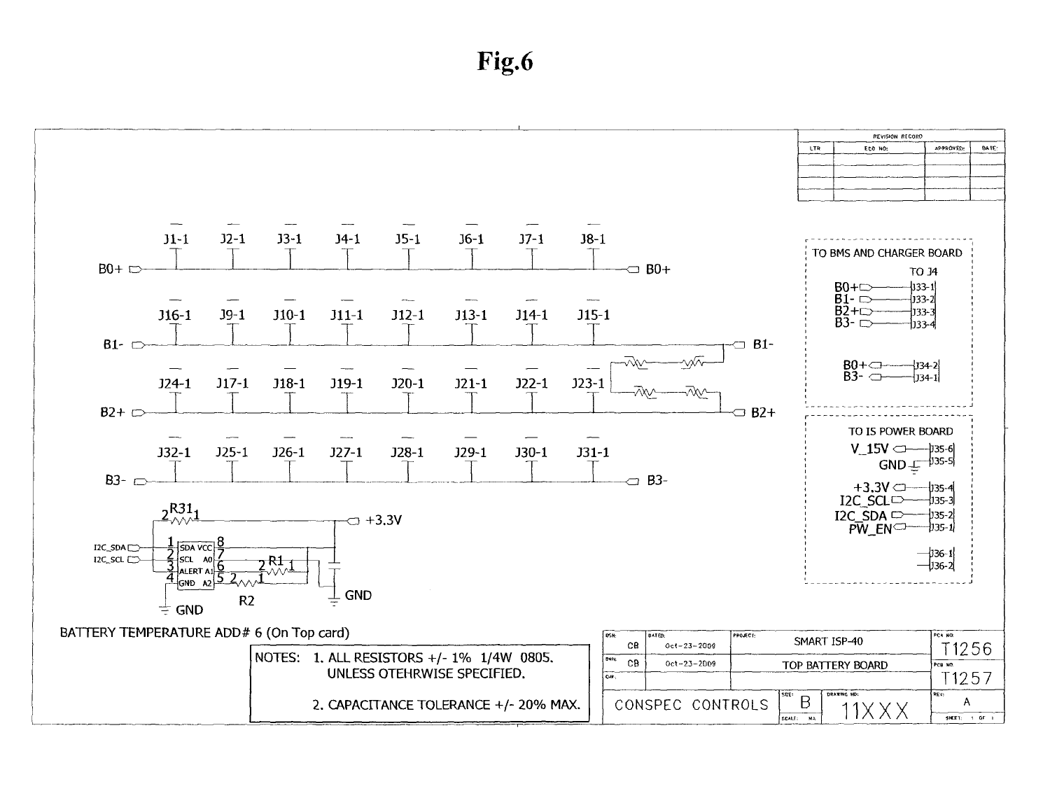

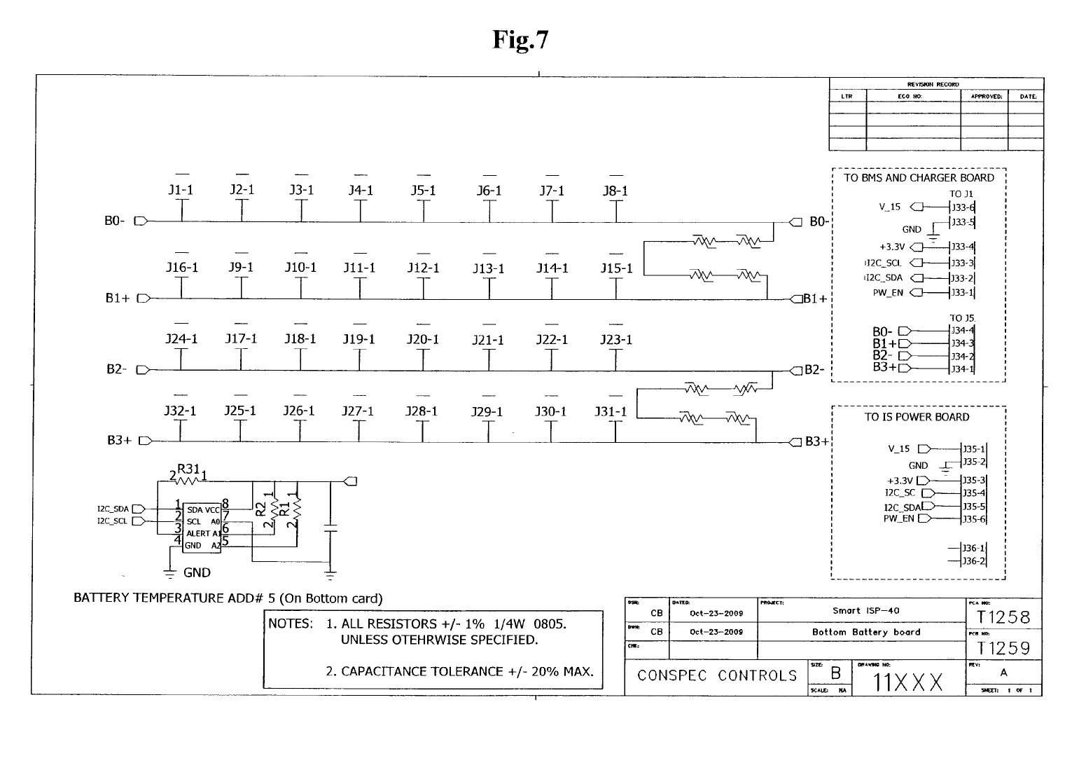

As shown schematically in FIGS. 4, 6 and 7, the batteries 44 of each fuel cell array 40A,40B are connected in electrical parallel by way of an internal electric conductor 72. Bridging wires 74 in turn are used to connect the fuel cell arrays 40A-D in series with the electrical negative terminal of each array 40 connected to the positive terminal of the next. As shown best in FIGS. 4 and 5, disposed along the bridging wire 74 is a first low temperature resettable thermal fuse 76, and three subsequent high temperature thermal fuses 78. Preferably, the low temperature fuse 76 is operable to interrupt current flow therepast and between battery arrays 40 upon the event of a first minimum threshold temperature selected at between about 70 and 90° C., and preferably about 75° C. The second subsequent high temperature fuses 78 are provided as a redundant safety feature. The fuses 78 are selected to trip and interrupt current flow therepast in the event of a threshold triggering temperature selected at between about 100° C. and 120° C., and preferably about 110° C. Each of the fuses 78 have an overall dimension selected to allow their positioning within the interspaces 64 or otherwise in proximity of the batteries 44. In this regard, the fuses 78 most preferably are formed having a thin generally elongated cylindrical body, and for example, may comprise 37M™ fuses which are manufactured by Chatham Components Inc. The applicant has appreciated that the positioning of the fuses 78 in the interspaces 64 advantageously ensures better fuse/battery thermal contact. This in turn provides greater reliability ensuring current flow across the fuel cell array 40 is interrupted in the event one or more of the batteries 44 exceeds an operating temperature which could otherwise result in damage or an explosion.

Although FIG. 8A illustrates the orientation of the batteries 44 in a hexagonally packing arrangement, other battery orientations are also possible By way of non-limiting example, FIG. 8B illustrates an alternate possible battery arrangement, where for example the batteries may be oriented in a square packing arrangement. The use of the square packing arrangement shown advantageously may allow for larger sized interspaces where, for example, greater numbers and/or larger sized fuses 76,78 are to be provided.

In the preferred embodiment shows the batteries 44 of each fuel cell arrays 40A-D as electrically connected to each other in parallel, providing the power supply 10 with a total of 13 volt, 40 amp hours output. It is to be appreciated however, that in an alternate construction, the fuel cell arrays 40A-D could be provided with each battery 44 thereof coupled in series. Although not essential, most preferably the fuel cell unit 16 is formed having a modular construction which allows for simplified removal or replacement in the event of defect or failure. In addition, the modular nature of the fuel cell unit 16 allows for multiple units 16 to be connected either in electrical series or parallel for larger and/or redundant backup power supplies, depending upon the site of installation. Although not essential, as shown best in FIG. 3, the unit 16 may be provided with an IS power output plug 82, one or more quick connect DC input plugs 81, as well as optionally, a non-intrinsically safe power output 83 when for example, additional back-up power may be required outside of IS operational modes.

Each of the fuel cell unit 16, charger/battery circuit 18, switching power circuit 20, thermal cutout fuse 28 and overload fuses 28 are fully encased within silicone 32. The silicone 32 acts as an electrically insulating potting material. More preferably, in assembly of the power supply 10, the silicone 32 is selected with a 0.83 specific gravity such as RTV352™ manufactured by General Electric Company. The applicant has appreciated that the use of lower specific gravity silicone advantageously allows for its free flowing into the interspaces 64 about each battery 44 to fully encapsulate not only the batteries 44, but also bridging wires electric conductor assemblies 72,74. The applicant has appreciated that with the IS power supply 10 as shown, any sparking which could arise at any electrical connection between the fuses 28,76,78, individual batteries 44, and/or the coupling between the fuel cell unit 16 and remaining power supply components is arrested and/or isolated from explosive gases by the enveloping silicone 32. Furthermore, the activation of the thermal fuses 28,76,78 are such as to trigger the interruption of any current overload conditions in the event of battery overcharge. The silicone 32, in addition to minimizing the formation and/or transmission of electrical sparks which could function as a catalysis to the ignition of explosive gases, furthermore advantageously ensures that the fuel cell unit 16, charger/battery circuit 18, switching power circuit 20 and fuses 28,74,76 are maintained fixed in the optimal positioning within the housing 14.

Optionally, the bottom mounting card 48 may be provided with a series of rubber cleats and/or feet (not shown) for facilitating the initial positioning of the unit within the housing 14 and maintaining the fuel cell unit 16 spaced from the bottom of the box 24 to allow for the free flow of silicone 32 thereunder. Although the detailed description describes the power supply as including a modular fuel cell unit 16, the invention is not so limited. It is to be appreciated that in an alternate construction, the power supply 10 could be manufactured with a dedicated fuel cell unit 16 which is customized to a specific IS power application.

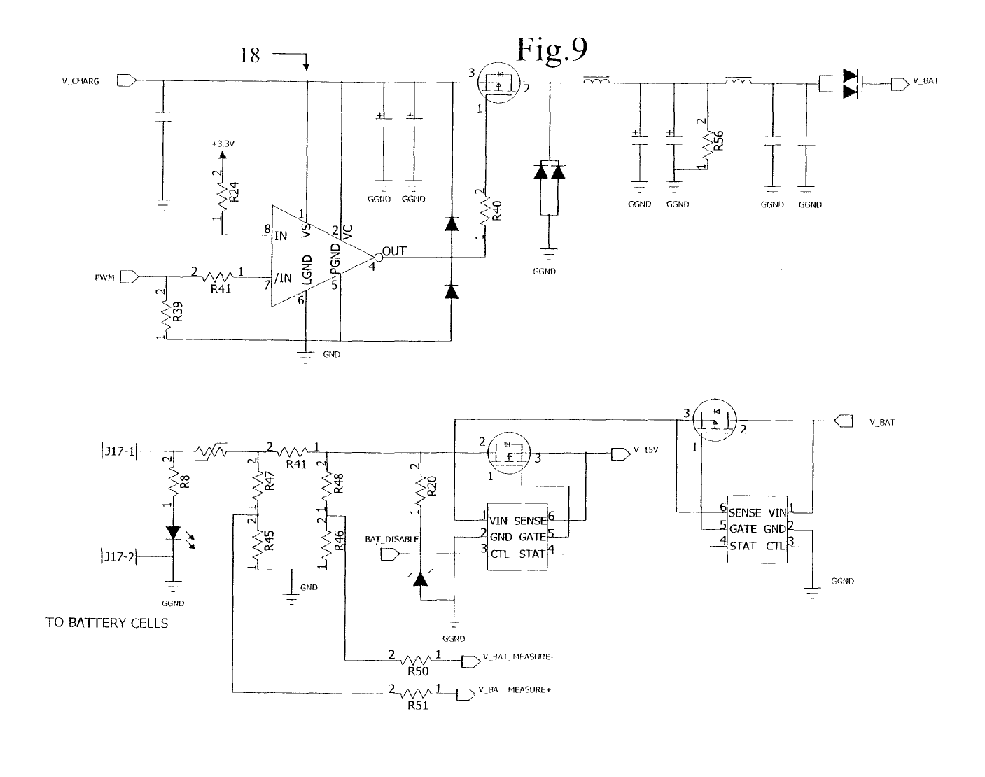

As described and shown best in FIG. 2 the fuel cell unit 16, charger/battery management circuit 18 and switching power circuit 20 as being housed entirely within the interior of the steel box 24. The charger/battery circuit 18 is electrically coupled to the power grid 12 by way of the input thermal overload fuse 28. As shown schematically in FIG. 9, under normal mine operational conditions the charging circuit 18 receives and converts DC current from the DC power supply 13 which is used to charge the fuel cell batteries 44 to maintain the power supply 10 in a ready state. To minimize the possibility of battery rupture or explosion as a result of the fuel cell unit 16 being over charged, in addition to the overload fuse 28 a thermal cut assembly 98 is provided as an overlay juxtaposed with the charger/battery circuit 18. The thermal cut out assembly 98 includes a series of fine thermally activated fuses which are provided in series, and configured to interrupt charging DC current flow from the grid 12 to the charger/battery circuit 18 on the occurrence of a minimum triggering temperature selected at about 130° C.

During normal operating conditions in the mine, the power supply 10 is connected to the mine DC power supply 13 to receive incoming power. Under such normal conditions the switching power circuit 20 receives power from the charger/battery circuit 15 VDC input voltage. When a hazardous condition occurs in the mine, all non-intrinsically safe power is turned off. Under such a power-off condition, the switching power circuit 20 receives its input power from the lithium iron phosphate fuel cell arrays 40a-40d. During the switchover of power, the power supply output voltage is uninterrupted, remaining at a preferred voltage nominally of 18 volts. It is to be appreciated that voltage will vary with different models from 10 to 24 volts. The output power is typically not inverted back to AC and fed into the grid for powering general equipment. Rather, in a most preferred mode of operation, the power supply 10 is provided as a general purpose IS power for powering other intrinsically safe equipment (not shown).

Where semiconductor devices are used for voltage regulation in equipment designed for use in coal mine areas where explosive gasses may be expected under normal conditions, it is necessary that the devices operate as shunt regulators, as contrasted with series regulators. The dominant failure mode for semiconductors is to fail in a short circuit condition. In the activation of a shunt regulator safe condition, as failure causes a fuse to blow and a zero voltage output. Another requirement is that any electronic component must not be rated at more than ⅔ of its normal operating voltage, current or power. If rated above this threshold it becomes a non-countable fault, and may be faulted in the most disadvantageous way regarding the safe operation of the circuit.

An inherent problem of using a shunt voltage regulator is that by definition, such regulators sink current (normally from the power source), when regulating the output voltage. The efficiency of a shunt regulator in its basic form is 0% at no load, as all the available supply current is shunted to the zero volt line to maintain the output at the required voltage, some current must always be shunted by the regulator to maintain the regulated output voltage.

An obvious disadvantage exists in that, when operating from the fuel cell bank, with limited fixed energy storage, some or all of that energy can be dissipated by the shunt regulator, shortening the available operating time of any equipment powered by the power supply. Shunt regulators for purposes generally incorporate zener diodes as the shunt device. Depending on the voltage and power required, zener diodes are expensive, can have high dynamic impedance, low initial accuracy, typically 5% for power zener diodes, and soft transfer characteristics at low currents, i.e. they shunt current at a voltage lower than their published operating voltage.

The switching power circuit 20 operates whenever the IS power supply 10 operates to supply output power to mine equipment connected to the supply output. While the mine mains AC power is available, the input to the switching power circuit 20 is supplied from the incoming nominal 15 volts DC power supply 13 that also supplies the charger/battery management circuit 18. When AC power is removed the switching power circuit 20 seamlessly gets its power from the lithium iron phosphate batteries 44.

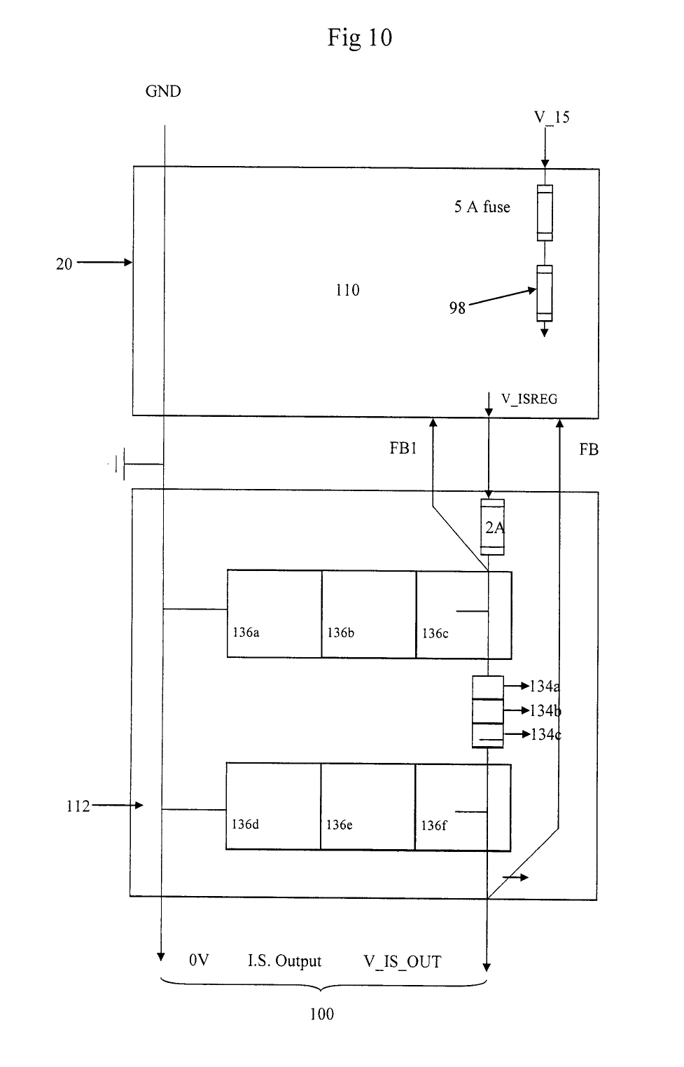

The switching power circuit 20 as shown in FIGS. 10 to 12 is a combination of two interrelated circuits: a pre-regulator circuit 110; and an active resistive power shunt regulator circuit 112. In the preferred construction, the active resistive shunt regulator circuit 112, when combined with the pre-regulator circuit 110, operates with three feedback paths to overcome problems associate with prior art.

The pre-regulator circuit received input power and is provided with a thermal current fuse 30 for incoming power; and a thermal fuse overlay as a thermal cutout assembly 98. The cutout assembly 98′ has substantially the same construction as cutout assembly 98, and interrupts current flow to the switching power circuit 20 on a minimum triggering temperature.

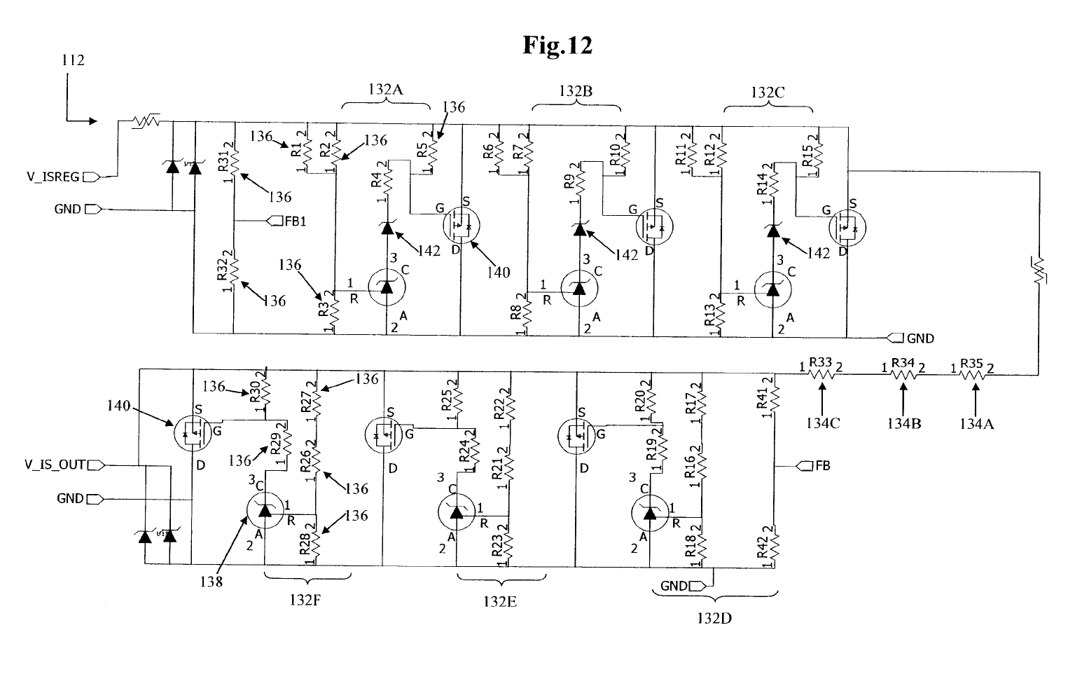

The active resistive shunt regulator circuit 112 as shown in FIGS. 10 and 12 consists of six active shunt regulators 132a,132b,132c,132d,132e,132f in two groups of three. The shunt regulators 132 are separated by infallible (as defined in the standards) resistors 134a,134b,134c. A typical shunt regulator circuit 132 is formed by regulator diode 130 and FET 140. The three shunt regulators 132a,132b,132c have an optional zener diode 142 in the circuit. The diode 142 is added to ensure that at the higher operating voltage of the shunt regulators 132a,132b,132c on the input side of the shunt regulator integrated circuit 112 is not operated at more than or equal to 66% of its normal rated operating voltage. Resistors 136 are chosen to set the shunt regulator circuit 112 operating voltage. Preferably the resistors 136 are precision low drift resistors (i.e. no variable resistors are used). In the three shunt regulators 132a,132b,132c on a different resistor arrangement is shown which allows the use of popular standard value precision resistors, when setting the voltage within the required tolerance.

In operation, the output voltage of the power supply 10 is essentially constant until a predefined load current. At this stage the output drops linearly at a rate defined by the maximum allowed value of V_ISREG and the value of the precision infallible resistors, until a maximum predetermined current is reached. On reaching the maximum predetermined current, output voltage drops quickly to zero at a pre-determined maximum short circuit current.

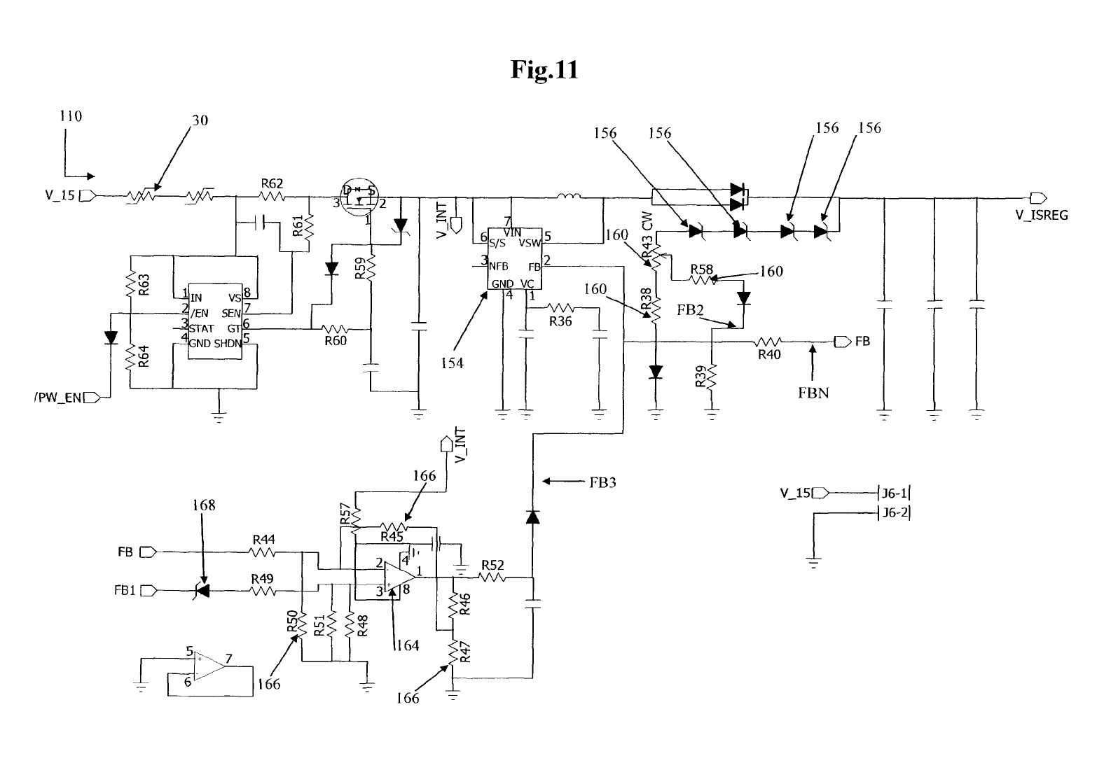

The switching power circuit 20 is constructed with an integrated step up switcher 154 (FIG. 11) having three feedback paths:
a) Normal feedback FBN sampled from the output of the active resistive shunt barrier regulator circuit 112 regulates the output to the required set voltage at normal operating current loads.
b) A second feedback path FB2 consists of a non-linear constant voltage feedback path consisting of a chain of diodes 156. This diode chain 156 is connected to an output of the pre-regulator circuit 110. Under normal operating conditions this feedback loop FB2 has no influence on the output voltage of the switching power circuit 20. However, because of the linear nature of infallible resistors 134a,134b,134c which are in series with the output of the switching power circuit 20 and the load powered by the power supply 10, as the output current increases, the voltage output of the switching power circuit 20 V_ISREG must rise to keep the output at the required output voltage. When V_ISREG =the operating voltage of the feedback circuit FB2 with resistors 160 the diodes of the diode chain 164 start to conduct electricity. The resultant current increases the voltage present at the feedback input. The feedback input effect on pin 2 of the switcher 154 stops any further increase of V ISREG, because when conducting, this feedback path has a much higher gain than the normal linear feedback FBN. which now has little or no affect on the output voltage. Thus at a chosen current, as for example 510 ma, voltage output begins to fall linearly as the load current increases, heading towards zero volts at some short circuit current value.
c) The Third feedback circuit FB3:
Upon the voltage difference sensed across the infallible resistors 134a,134b,134c by differential amplifier 164 with associated resistors 166 and diode 168, reaches a preset value, the output of amplifier 164, which has a reasonably high gain, begins to rise. Once the output of amplifier 164 rises sufficiently it overrides the feedback from FBN or FB2, and forces the output of the switching power circuit 20 to a voltage that sets the output short circuit current to a chosen low level.

The active shunt regulator circuit 112 does not rely on capacitors for stability or voltage smoothing, the circuit 112 has much sharper transfer characteristics as compared to power zener diodes. As such, the output voltage of the pre-regulator circuit 110 may be set much closer to the shunt regulator operating voltage, without the shunt regulator shunting current and thus shortening battery standby life. The active shunt regulator circuit 112 has a much more accurately defined operating voltage and a lower dynamic impedance when conducting, thus the output voltage is essentially constant when the shunt current increases.

Another advantage of the present design resides in that the rated output voltage, and rated maximum current at that voltage, as well as the rate of decline of output voltage above the current and the ultimate short circuit current can be set by changing resistors. By varying resistor values , it is possible to set the shunt voltages both for the input shunts and output shunt regulators. The shunt regulators 132 only operate under fault conditions, i.e. if the pre-regulator circuit 110 fails and tries to output a high voltage or if a transient voltage comes in from the load. The present construction provides enhanced safety redundancies allowing its wider use in IS power supply applications

Although groups of three shunt regulators 132 are shown in FIG. 12, it is to be appreciated that in some situations only two shunt regulators 132 in each group will be installed or required by the applicable standard.

While the detailed description describes and illustrates the power supply 10 as providing a back-up power supply for use in underground mine applications, the invention is not so limited. It is to be appreciated that the power supply 10 is equally suited for use in other hazardous environments where, for example, combustible gases, liquids and/or materials may be present. Such installations could include without restriction chemical plants, petrochemical and refinery installations, military facilities and/or ordinance storage installations, marine applications, in civilian and/or military vehicles as well as, railway and aircraft.

The detailed description describes the power supply 10 as providing back-up power supply for the ongoing operation of emergency lighting, underground gas sensors and/or ventilation and communication equipment. It is to be appreciated that the power supply 10 is not restricted to the preferred uses which are disclosed.

Although the detailed description describes the heat sink 34 as a flat piece of copper, the invention is not so limited. In an alternate construction, the heat sink 34 may include a series of spaced metal fins. If present, fins may be provided in thermal contact with a side portion of the fuel cell unit 16, and which extend through a sidewall of the box 24 to better dissipate any generated heat therefrom.

While the preferred embodiment describes the power supply 10 as including lithium iron phosphate batteries 44, it is to be appreciated that other types of batteries may also be used including, without limitation, other battery types, including other lithium ion batteries, without departing from the spirit and scope of the invention.

Although the detailed description describes and illustrates various preferred embodiments, the invention is not so limited. Many variations and modifications will now occur to persons skilled in the art. For a definition of the invention, reference may be had to the appended claims.

1. An underground mine supply for supplying back-up power to an underground mine in a power-out event, the power supply comprising:
a housing,
an electrically insulating potting material,
at least one lithium iron based fuel cell for supplying a back-up current during said power-out event, each said fuel cell being disposed within said housing and substantially encased within said potting material,
a charging circuit electrically connected to a first one of said fuel cell and an external power source for providing a charging current to said first fuel cell during normal power-on conditions, and
a switching power circuit electrically connecting at least one said fuel cell and a power supply output for outputting said backup current during said power-out event.

2. The power supply as claimed in claim 1, comprising a plurality of said fuel cells, each fuel cell comprising a generally longitudinally elongated cylindrical lithium iron phosphate battery, said batteries being housed in a generally longitudinally aligned and hexagonally packed orientation.

3. The power supply as claimed in claim 1, wherein the charging circuit electrically communicates with a first thermal cut-off switch operable to interrupt flow of said charging current on the occurrence of a first preselected minimum threshold temperature.

4. The power supply as claimed in claim 3, wherein said first threshold temperature is selected at about 75° C.

5. The power supply as claimed in claim 3, wherein the switching power circuit electrically communicates with a second thermal cut-off switch, operable to interrupt flow of said back-up current on the occurrence of said threshold temperature.

6. The power supply as claimed in claim 1, wherein said charging current comprises a DC current.

7. The power supply as claimed in claim 1 further comprising at least one fusible conductor electrically connecting a plurality of said fuel cells in series, the fusible conductor comprising a current interrupting member operable to interrupt current flow therepast in the event of a preselected triggering condition.

8. The power supply as claimed in claim 7, wherein the current interrupting member comprises a low temperature thermal fuse, and the triggering condition comprises a minimum threshold temperature selected at about 75° C.

9. The power supply as claimed in claim 1, wherein the potting material comprises essentially silicone.

10. A power supply for supplying back-up power during a power-out event, the power supply comprising:
a housing,
an electrically insulating potting material,
a fuel cell array comprising a plurality of fuel cells for supplying a back-up current during said power-out event, each said fuel cell being disposed within said housing and substantially encased within said potting material,
at least one conductor bridge electrically connecting a plurality of said fuel cells in series, the connector bridge comprising at least one current interrupting member which is actuable to interrupt current flow in the event of a preselected triggering condition,
a charging circuit electrically connected to a first said fuel cell and an external power source for providing a charging current to said first fuel cell during normal power-on conditions, and
a switching power circuit electrically connecting the fuel cell array and a power supply output for outputting said backup current during said power-out event.

11. The power supply as claimed in claim 10, wherein the conductor bridge comprises two of said current interrupting members,
a first said current interrupting member comprising a low temperature thermal fuse actuable to interrupt current flow along said conductor bridge on a minimum triggering temperature selected at about 75° C., and
the second other said current interrupting member comprising a high temperature fuse actuable to interrupt current flow along said conductor bridge on a minimum triggering temperature selected at about 130° C.

12. The power supply as claimed in claim 11, wherein the fuel cells each comprise a generally cylindrical fuel cell for supplying a backup current during said power-out event, the fuel cells being disposed in an orientation selected from a generally square packed orientation and a generally hexagonally packed orientation to define longitudinally extending interspaces therebetween.

13. The power supply as claimed in claim 12, wherein said fuel cells are electrically connected in series, the first and second current interrupting members being disposed within a selected one of said interspaces.

14. The power supply as claimed in claim 10, wherein the charging circuit electrically communicates with a first thermal cut-off switch operable to interrupt said charging current on the occurrence of a preselected minimum temperature selected at least about 130° C., and preferably at about 150° C.

15. The power supply as claimed claim 10, wherein the switching power circuit electrically communicates with a second thermal cut-off switch operable to interrupt flow of said back-up current on the occurrence of said preselected minimum temperature selected at about at least 130° C., and preferably at about 150° C.

16. The power supply as claimed in claim 10 wherein the potting material comprises essentially silicone.

17. The power supply of claim 10, wherein each said fuel cells comprises a sealed lithium iron phosphate battery.

18. The power supply as claimed in claim 17, wherein said fuel cells are spaced from a next adjacent fuel cell by a minimum distance selected at between about 0.5 and 3 mm.

19. The power supply as claimed in claim 17, wherein said lithium iron phosphate battery each comprise a sealed rechargeable battery having a voltage selected at between about 2 and 5 volts, and preferably about 3 to 4 volts.

20. An power supply for supplying backup power during a power-out event, the power supply comprising:
a housing,
an electrically insulating silicone potting material,
at least one fuel cell array comprising a plurality of electrically rechargeable lithium iron phosphate fuel cells for supplying a backup current during said power-out event, the fuel cells being generally of equal size and disposed in an aligned and hexagonally packed orientation to define longitudinally extending interspaces therebetween, said fuel cells being electrically connected in series and disposed within said housing substantially individually encased within said potting material,
at least one conductor bridge electrically connecting a plurality of said fuel cells in series, the connector bridge comprising at least one current interrupting member which is actuable to interrupt current flow in the event of a preselected triggering condition,
a charging circuit electrically connected to a first one of said fuel cell and an external power source for providing a charging current to said at least one fuel cell array during normal power-on conditions, and
a switching power circuit electrically connecting at least one said fuel cell and a power supply output for outputting said backup current during said power-out event.

21. The power supply of claim 20 comprising a plurality of said conductor bridges, a selected one of said current interrupting member of each said conductor bridge being disposed in an associated one of said longitudinally extending interspaces.

22. The power supply as claimed in claim 20 wherein each of said plurality of fuel cells are spaced from a next adjacent fuel cell by a minimum distance selected at between about 0.5 and 3 mm.

23. (canceled)

24. The power supply as claimed in claim 20 comprising at least four of said fuel cell arrays, each said fuel cell array comprising between 5 and 12 rechargeable batteries.

25. The power supply as claimed in claim 20, wherein said housing comprises a substantially sealed housing.

26. The power supply as claimed in claim 20 wherein said housing comprises a sealed stainless steel housing, and further comprising a heat sink for transferring thermal energy from at least one of said fuel cell arrays to an exterior region of said housing.

27. The power supply as claimed claim 20 wherein the silicone potting compound has a specific gravity selected at between about 0.8 and 1, and preferably about 8.2 to 8.4.

28. The power supply as claimed in claim 20 wherein the charging circuit and switching power circuit are substantially encapsulated within the potting material.
